(19) United States
(12) Patent Application Publication
(10) Pub. No.: US 2011/0296492 A1
(43) Pub. Date: Dec. 1, 2011

(54) Method of world-wide website registration

(76) Inventor: Fayek Todary Michael, Roxboro (CA)

(21) Appl. No.: 13/069,000

(22) Filed: May 26, 2011

Related U.S. Application Data
(60) Provisional application No. 61/349,310, filed on May 28, 2010.

(51) Int. Cl. G06F 7/04; G06F 11/30

(52) U.S. Cl. 726/3

(57) ABSTRACT

The present document describes a method of registering a world wide website by a registration authority comprising: providing to a website owner a pre-registration logo to be posted on a website while verifying data received from said website owner, announcing the website in WWWSR data base as pre-registered, during an opposition period, if there is an opposition, the mediation process is initiated to determine the validity of registering of the recently filed website or if there are no oppositions, the website will be registered after the specified delay period.

### CROSS-REFERENCE TO RELATED APPLICATIONS

This application claims the benefit to provisional application 61/349,310.

### TECHNICAL FIELD

This description relates to the field of world-wide website registration and authentication.

### BACKGROUND

When a computer connects to a network and begins communicating with other computers, it is essentially taking a risk. Internet security involves the protection of a computer's Internet account and files from intrusion of an unknown user. Basic security measures involve protection by well selected passwords, change of file permissions and back up of computer's data.

Security concerns are in some ways peripheral to normal business working, but serve to highlight just how important it is that business users feel confident when using IT systems. Security will probably always be high on the IT agenda simply because cyber criminals know that a successful attack can be very profitable. This means they will always strive to find new ways to circumvent IT security, and users will consequently need to be continually vigilant. Whenever decisions need to be made about how to enhance a system, security will need to be held uppermost among its requirements.

There is therefore a need for improved security of the internet.

### SUMMARY

It is an object of the present disclosure to provide a secure internet environment as a useful alternative.

According to an embodiment, there is provided a method of registering a world wide website by a registration authority comprising:

providing to a website owner a pre-registration logo to be posted on a website while verifying data received from said website owner,

announcing the website in WWWSR data base as pre-registered, during an opposition period,

if there is an opposition, the mediation process is initiated to determine the validity of registering of the recently filed website or if there are no oppositions, the website will be registered after the specified delay period.

According to another embodiment, there is provided a method of authenticating a safe and legitimate world wide website comprising:

comparing an authentication signal provided by said world wide website to an authentication signal obtained from a registration authority,

wherein said authentication signal is prepared by said registration authority from an authenticated registration information and an authenticated programming code of said world wide website, and

wherein when said authentication signal is identical, at least one of the registration of said world wide website, the safety of said world wide website, and the protection against a malicious computer program of said world wide website, is confirmed to said visitor.

### DETAILED DESCRIPTION

Mission:

a) To protect website owners'/establishers' copyright, know-how and creative talent from imitation.

b) To prevent web fraud by registering and knowing details of site owners.

c) Providing peace of mind to people who are surfing the web, since they visit registered sites of known origin.

d) Providing safe surfing by protecting the registered sites from viruses and spying.

The Following are the Main Advantages of Registering Websites Worldwide with WWWSR.

1) To protect a site information from imitation or being copied to establish a new competitor site. [Imitation does not mean the same kind of service but copying the contents of other site(s)].

2) To protect website specific descriptive wordings, that allow search engines keep your site on top of the list.

3) Registered site will carry the logo of RS (i.e. registered site). Therefore any imitator searching WWWSR data base will know that their site will be refused for registration because of imitation (or copying from any registered site of the same activity) [imitation does not mean the same kind of service but copying the contents of other site(s)].

4) The registration of specific site will make it unique and protected from the dilemma and crowd that is going on the web.

5) Registered site will show higher quality and give confidence to sit visitors and they will deal with it as a trusted one.

6) Visitors of registered sites will have a peace of mind that the information about the visited site(s) and its (their) owners are registered with WWWSR, this will increase their trust in visited sites and will gradually minimize web fraud by the increased number of registered sites.

7) Registered site will be backed up and protected when registered with WWWSR. While site owners are busy in promoting their business, WWWSR will be safeguarding their sites from imitators and will inform them once a similar site-registration request is filed with WWWSR. This will give site owner the chance of two month to oppose the newly filed site for registration (if owner of registered sit feels it is just imitation of his/her site).

8) In case of lodging an opposition, every party will provide his prove of right to WWWSR that will raise the issue to its arbitration board (AB) for decision. The decision of AB is final based on fair preset criteria.

9) Once a site is registered will carry the two important items:

The logo for confirming registration and safety.

Virus and scam protection logo (that will be provided by WWWSR for registered site protection).

10) All registered sites will be virus and scam protected this will encourage surfing people to visit them with peace of mind while avoiding other unregistered sites.

11) If registered site is advertising site this will be known through WWWSR data base so that advertisers will come to those sites and purchase the advertising service.

12) By repeated advertising at specific site, will expand its business and become more known to surfing people.

Steps for Filing, Pre-Registration and Registration of Website:

### 1) Step One:

Opening a file and providing information to initiate registration process=free of charge

When a new file for pre-registration is opened “the follow up alert system (FAS) from WWWSR” will automatically advise all the registered sites (for free) and having the same activity of the newly pre-registered domain (i.e. specialty), to allow any one of the subscribers to review the new site filed, if noticed any conflict, between his/her/its site, then will have the option to lodge an opposition to examine the new application for eligibility for WWWSR, if conflict exist then WWWSR would request site modification to avoid conflict, and allow registration of the new site after modification.

### 2) Step Two:

Pre-registration: Proceeding with full steps of registration, and wait for 60 days delay period, after completion, during this period the applicant will be given the logo of completing pre-registration and the full virus and scam protection, and announcing the site in WWWSR data base as pre-registered, but the 60 days delay to allow any opposition from others to appear during that period. If no opposition after 60 days the Registration of the site will be announced in WWWSR data base that its final registration has completed and will be given the registration logo and the full virus and scam protection. Any opposition after this period will not be considered. [A Follow-up Alert System (FAS)] is available [for free] from WWWSR to advise the registered site owners of newly pre-registered sites of the same activity to be examined by them for copying or obvious imitation by the new candidate site.

Fees for Pre-registration:

Pre-Registered Business Trade site selling physical products=PRBT=USD 80.00

Pre-Registered Business Trade site selling physical products and advertising for others=PRBT/A=USD 120.00

Pre-Registered Business selling Service site=PRBS=USD 70.00

Pre-Registered Business selling Service site and advertising for others=RBSA=USD 110.00

Pre-Registered Business informative site=PRBI=70.00

Pre-Registered Business informative site and advertising for others=PRBI/A=USD 110.00

Pre-Registered Personal Trade site selling physical products=PRPT=USD 70.00

Pre-Registered Personal Trade site selling physical products and advertising=PRPT/A=USD 90.00

Pre-Registered personal site selling Service=PRPS=USD 60.00

Pre-Registered personal site selling Service and advertising=PRPS/A=USD 80.00

Pre-Registered Personal informative site=PRPI=USD 60.00

Pr-Registered Business informative site and advertising=PRPI/A=USD 80.00

### 3) Step Three:

Final registration: final registration costs will include additional (to preregistration fee) 50% for business and $40% for personal sites procedures as explained above:

After 60 days with no opposition, the site will be protected and will announce its complete registration.

If during 60 days an opposition is lodged by another then the announcement of registration will be suspended until situation is resolved. In this case the new filed site will be marked opposed until opposition is solved.

If no opposition arises during 60 days, the site will be registered, protected and obtain' the registration logo. Any opposition after the 60 days period will not be considered.

Conflict situation would be resolved by one of the following ways:

1. Mediation by WWWSR Staff

Upon request of opposing site or the newly filed one the two conflicting parties WWWSR will be mediated by WWWSR staff to be able to adjust the two sites to remove the conflicting parts, imitation, or the cause of conflict. If resolution completed within one month and approved by both parties then both sites will be announced as registered and will acquire the logo, protection and announced as registered. This process will be against procedure fees from both parties for USD 120 each.

2. Mediation by Arbitration Committee

If the mediation process is not accepted by one of the parties, the files will be raised to the arbitration committee and its decision is final. In this case procedure fee is applicable on the objecting side, (to the staff recommendation), This fee will be USD 240. The other party will have no charges to pay. If both sides are objecting to the staff recommendation each party will charged a fee of USD 240

If the new site refuses to go through Mediation or Arbitration process then, the new site will not be registered, and the original site (who opposed the other new party that refused to accept the mediation and Arbitration) will be kept on the registry with protection plus the descriptive logo.

The registration fee will cover 24 month period after that period a renewal fee will be applicable.

The fee for Final registration is 50% (business) and 40% (personal) of the fee of pre-Registration. This fee gives protection for 24 month.

Renewal fees: will be 40% of the Registration fee (for another 24 month)

Building up the Business Domain List (i.e. Site Nature and its Activities)

The applicants will be classified in the WWWSR data base according to their business domain (business type).

The applicant while filing his site will define his domain that will be collected in the WWWSR data base section for domains listing. Any new applicant can chose his domain from the previously existing list of domains or add a new domain (that does not exist) to the list. The domains list will build up automatically allowing no duplication. Any conflict in definition of new domain, The case will be examined by WWWSR staff and an advice will be sent to the applicant to correct the definition or guiding him/her/it to the correct name or the definition of the new domain or sub-domain (ex. Health domain would be sub-divided to Pharmacy, Physician, disease, Herbal medicine, etc.)

This will help the automation of the system, i.e. when a new file for pre-registration is opened the (FAS) system will automatically advise all the registered sites and having the same business domain (activity) of the speciality of the newly pre-registered site, to allow any one of the subscribers to review the new site filed, if noticed any conflict, between his/her/its site, then will have the option to lodge an opposition to examine the new application for eligibility to register with WWWSR, if conflict exist then WWWSR would request site modification to avoid conflict, and allow registration of the new site if adjusted accordingly.

Specific Descriptive Wording: “Talented Words”

Every website owner is trying to select words or expression that cause his/her/its web page to appear first or on the top of list.

Apart from common words known for each domain (activity) some people can create what is called “Talented words” that are not common and confirmed not used by others upon searching. WWWSR will be able to register those talented words for their owners to be used for their web pages exclusively.

### Example 1

### WWWSR (World-Wide Website Registration)—Application Form for Business Site

### Example 2

### WWWSR (World-Wide Website Registration)—Application Form for Personal Site

### Example 3

### Codes that will be used on the Logo given to Registered Websites

The logo for registered sites will carry few letters that will give a description of the nature of the site and its activities plus country code of its origin. (see attachment)

See country code keys at the tail. (Country codes will be numbers, ex. Canada=1 USA=2 UK=3 France=4 Germany=5 . . . etc.

Registered Business Trade site selling physical products=RBT

Registered Business Trade site selling physical products and advertising for others=RBT/A

Registered Business selling Services site=RBS

Registered Business selling Services site and advertising for others=RBS/A

Registered Business only informative site=RBI

Registered Business informative site and advertising for others=RBI/A

Registered Personal Trade site selling physical products=RPT

Registered Personal Trade site selling physical products and advertising=RPT/A

Registered personal site selling Service=RPS

Registered personal site selling Service and advertising=RPS/A

Registered Personal only informative site=RPI

Registered Business informative site and advertising=RPIA

The given WWWSR logo will carry one of the above codes+country code+year of registration

For example: A logo that carries the code (RBTA-1/2010) means Registered Business trading site and advertising from Canada registered year 2010.

Visitors will see country codes: by clicking on special button or type the number on search window on WWWSR web-site then they can find which country code they entered.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A method of authenticating a safe and legitimate world wide website comprising:
comparing an authentication signal provided by said world wide website to an authentication signal obtained from a registration authority,
wherein said authentication signal is prepared by said registration authority from an authenticated registration information and an authenticated programming code of said world wide website, and
wherein when said authentication signal is identical, at least one of the registration of said world wide website, the safety of said world wide website, and the protection against a malicious computer program of said world wide website, is confirmed to said visitor.

2. The method as claimed in claim 1, wherein said registration authority prepares a safeguard copy of said world wide website.

3. A method of registering a world wide website by a registration authority comprising:
providing to a website owner a pre-registration logo to be posted on a website while verifying data received from said website owner,
announcing the website in WWWSR data base as pre-registered during a pre-registered period or during an opposition period.
If there is an opposition, the mediation process is initiated to determine the validity of registering of the recently filed website, or if there are no opposition, the website will be registered after the specified delay period.

4. The method as claimed in claim 3, further comprising a step of monitoring application to avoid similar site-registration by notifying previously registered website owner and allowing them to oppose to newly file site for registration in case of any coping or obvious imitation.
